(19) United States
(12) Patent Application Publication
(10) Pub. No.: US 2025/0227600 A1
(43) Pub. Date: Jul. 10, 2025

(54) ELECTRONIC DEVICE AND METHOD FOR NETWORK MANAGEMENT, AND COMPUTER-READABLE STORAGE MEDIUM

(71) Applicant: Sony Group Corporation, Tokyo (JP)

(72) Inventors: Shuo WANG, Beijing (CN); Chen SUN, Beijing (CN)

(73) Assignee: Sony Group Corporation, Tokyo (JP)

(21) Appl. No.: 18/851,079

(22) PCT Filed: Mar. 27, 2023
(86) PCT No.: PCT/CN2023/083978

§ 371 Date: Sep. 26, 2024

(30) Foreign Application Priority Data
Apr. 6, 2022 (CN) 202210355984.X

(51) Int. Cl. H04W 48/08; H04W 24/02; H04W 60/04; H04W 60/06

(52) U.S. Cl. CPC H04W 48/08; H04W 24/02; H04W 60/04; H04W 60/06

(57) ABSTRACT

The present disclosure provides an electronic device and method for network management, and a computer-readable storage medium. The electronic device comprises a processing circuit configured to control the operation of a network slice admission control function (NSACF) of a network slice in a mobile network on the basis of a blockchain, wherein the NSACF has a blockchain function.

This application claims priority to Chinese Patent Application No. 202210355984.X titled “ELECTRONIC DEVICE AND METHOD FOR NETWORK MANAGEMENT, AND COMPUTER-READABLE STORAGE MEDIUM”, filed on Apr. 6, 2022 with the China National Intellectual Property Administration (CNIPA), which is incorporated herein by reference in its entirety.

### FIELD

Embodiments of the present disclosure generally relates to the field of wireless communications and in particular to admission control for a network slice in a mobile network, and more particularly to an electronic apparatus and a method for network management, and a computer-readable storage medium.

### BACKGROUND

In TS 23.501 V17.3.0 Section 5.15.11, a Network Slice Admission Control Function (NSACF) is defined, which is intended to monitor and control the number of registered users and the number of PDU sessions of a slice. NSACF configures the maximum allowable number of registered users and PDU sessions for each slice that requires admission control (NSAC), and indication information of available access types (3GPP access, or non-3GPP access). NSACF further provides network functions of event-based slice status notification and reporting to other consumers. According to the existing standards, only a global maximum allowable value is configured for admission control for one slice. However, one slice may be associated with multiple service areas, and each service area is under admission control by a separate NSACF. In this scenario, how to coordinate admission control of a single slice among multiple NSACFs is not solved.

### SUMMARY

In the following, an overview of the present disclosure is given simply to provide basic understanding to some aspects of the present disclosure. It should be understood that this overview is not an exhaustive overview of the present disclosure. It is not intended to determine a critical part or an important part of the present disclosure, nor to limit the scope of the present disclosure. An object of the overview is only to give some concepts in a simplified manner, which serves as a preface of a more detailed description described later.

According to an aspect of the present disclosure, an electronic apparatus for network management is provided. The electronic apparatus includes processing circuitry configured to: control, based on a blockchain, an operation of a Network Slice Admission Control Function (NSACF) of a network slice in a mobile network, where the NSACF has a blockchain function.

According to another aspect of the present disclosure, a method for network management is provided. The method includes: controlling, based on a blockchain, an operation of a Network Slice Admission Control Function (NSACF) of a network slice in a mobile network, where the NSACF has a blockchain function.

In the electronic apparatus and method according to the above aspects of the present disclosure, blockchain technology is utilized to realize coordination of admission control among different NSACFs of the same network slice, and an admission quota of the network slice is shared.

According to an aspect of the present disclosure, an electronic apparatus for network management is provided. The electronic apparatus includes processing circuitry configured to: acquire spectrum sensing information from a radio access network side; and dynamically update a slice admission quota of each network slice in a mobile network based on the spectrum sensing information.

According to another aspect of the present disclosure, a method for network management is provided. The method includes: acquiring spectrum sensing information from a radio access network side; and dynamically updating a slice admission quota of each network slice in a mobile network based on the spectrum sensing information.

In the electronic apparatus and method according to the above aspects of the present disclosure, the slice admission quota of each network slice is dynamically updated based on the spectrum sensing information, so that a spectrum usage efficiency of the radio network can be effectively optimized.

According to other aspects of the present disclosure, there are further provided computer program codes and computer program products for implementing the methods for network management above, and a computer-readable storage medium having recorded thereon the computer program codes for implementing the methods for network management described above.

These and other advantages of the present disclosure will be more apparent from the following detailed description of preferred embodiments of the present disclosure in conjunction with the accompanying drawings.

### BRIEF DESCRIPTION OF THE DRAWINGS

To further set forth the above and other advantages and features of the present disclosure, detailed description will be made in the following taken in conjunction with accompanying drawings in which identical or like reference signs designate identical or like components. The accompanying drawings, together with the detailed description below, are incorporated into and form a part of the specification. It should be noted that the accompanying drawings only illustrate, by way of example, typical embodiments of the present disclosure and should not be construed as a limitation to the scope of the disclosure.

In the accompanying drawings:

FIG. 1 shows a block diagram of functional modules of an electronic apparatus for network management according to an embodiment of the present disclosure;

FIG. 2 shows an example of a system scenario to which the technology of an embodiment of the present disclosure is applied;

FIG. 3 shows an example of a relevant information flow of admission control of the number of slice users;

FIG. 4 shows an example of a relevant information flow of admission control of the number of protocol data unit sessions;

FIG. 5 shows a block diagram of functional modules of an electronic apparatus for network management according to another embodiment of the present disclosure;

FIG. 6 shows an example of an information flow of updating a slice admission quota;

FIG. 7 shows another example of an information flow of updating a slice admission quota;

FIG. 8 shows a flow chart of a method for network management according to an embodiment of the present disclosure;

FIG. 9 shows a flow chart of a method for network management according to another embodiment of the present disclosure;

FIG. 10 is a block diagram showing an example of a schematic configuration of a server; and

FIG. 11 is a block diagram of an exemplary block diagram illustrating the structure of a general purpose personal computer capable of realizing the method and/or device and/or system according to the embodiments of the present disclosure.

### DETAILED DESCRIPTION

An exemplary embodiment of the present disclosure will be described hereinafter in conjunction with the accompanying drawings. For the purpose of conciseness and clarity, not all features of an embodiment are described in this specification. However, it should be understood that multiple decisions specific to the embodiment have to be made in a process of developing any such embodiment to realize a particular object of a developer, for example, conforming to those constraints related to a system and a service, and these constraints may change as the embodiments differs. Furthermore, it should also be understood that although the development work may be very complicated and time-consuming, for those skilled in the art benefiting from the present disclosure, such development work is only a routine task.

Here, it should also be noted that in order to avoid obscuring the present disclosure due to unnecessary details, only a device structure and/or processing steps closely related to the solution according to the present disclosure are illustrated in the accompanying drawing, and other details having little relationship to the present disclosure are omitted.

### First Embodiment

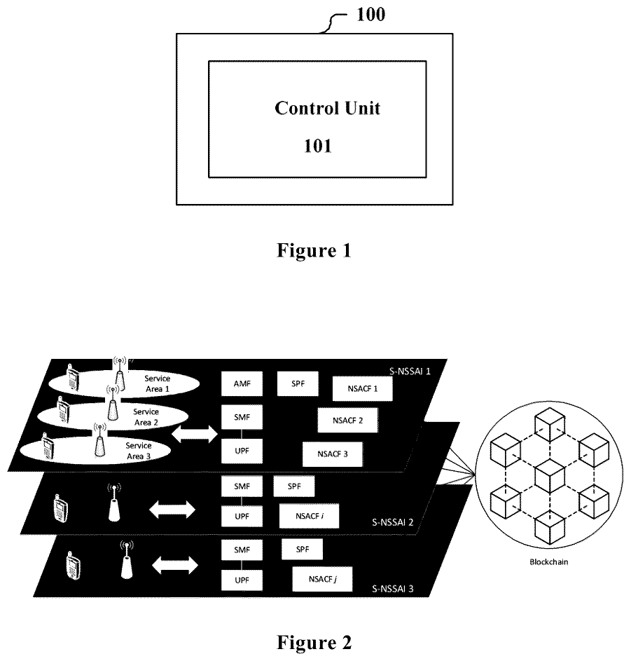

FIG. 1 shows a block diagram of functional modules of an electronic apparatus 100 according to an embodiment of the present disclosure. As shown in FIG. 1, the electronic apparatus 100 includes a control unit 101. The control unit is configured to control, based on a blockchain, an operation of a Network Slice Admission Control Function (NSACF) of a network slice in a mobile network, where the NSACF has a blockchain function.

The control unit 101 may be implemented by one or more processing circuits. The processing circuitry may be implemented as a chip or a processor, for example. It should be understood that various functional units in the electronic apparatus shown in FIG. 1 are only logical modules divided based on specific functions thereof, and are not for limiting a specific implementation.

For example, the electronic apparatus 100 may be provided on a core network side of a mobile network, specifically on a server on the core network side. More specifically, the electronic apparatus may serve as a part of the NSACF. Examples of mobile networks include, for example, a Public Land Mobile Network (PLMN).

Here, it should also be noted that the electronic apparatus 100 may be implemented at a chip level or at a device level. For example, the electronic apparatus 100 may operate as the server itself and may further include a memory, a transceiver (not shown), and other external devices. The memory may store related data information and programs that the electronic apparatus needs to execute to achieve various functions. The transceiver may include one or more communication interfaces to support communications with different devices (such as another server, a base station, and the like). An implementation of the transceiver is not specifically limited here.

FIG. 2 shows an example of a system scenario to which the technology of the embodiment is applied. In this example, the mobile network is a PLMN, and a PLMN includes multiple network slices. A 5G core network of the network slice can deploy the NSACF based on an admission control requirement, to monitor and control the number of registered users and the number of sessions of a Protocol Data Unit (PDU) of the network slice. In a case that one network slice serves multiple service areas, such as network slice 1 in FIG. 2 (indicated by S-NSSAI 1), each service area corresponds to one NSACF, and therefore one network slice corresponds to multiple NSACFs. In this case, it is expected that multiple NSACFs share a registered user number quota and a PDU session number quota of the network slice 1. The quota here may be understood as a maximum number allowed or configured.

In addition, each network slice may have an independent session management function (SMF), a user plane function (UPF), an NSACF, and a sensing plane function (SPF). Each network slice may have an independent access and mobility function (AMF), or multiple network slices may share an AMF.

In order to realize the coordination of admission control among multiple NSACFs of a network slice, a solution based on blockchain technology is proposed in the embodiment. In this way, information related to slice admission control and resource management of each NSACF can be recorded in real time through the blockchain technology, thereby achieving coordination among multiple NSACFs.

The NSACFs of network slices form a blockchain. For example, each NSACF has a blockchain function, saves a local ledger, and can interact with each other through, for example, a P2P network. A schematic example is shown in FIG. 2. The blockchain may record admission control information of each NSACF of each network slice. Hereinafter discussed mainly are two examples of admission control, i.e., availability check and update processing of the number of slice users, and availability check and update processing of the number of PDU sessions. However, it should be understood that this is not limiting, and other types of admission control and associated admission control information are within the scope of the present disclosure.

For example, the control unit 101 is configured to perform, in response to a predetermined trigger event with respect to a first NSACF, admission control of a current network slice corresponding to the first NSACF based on the blockchain. Here, the term “first” is only for convenience of distinguishing and does not have any meaning, such as indicating an order.

For example, the electronic apparatus 100 or the control unit 101 may be arranged on the NSACF or serve as a part of the NSACF. Taking FIG. 2 as an example, in a case that NSACF 1 of a network slice S-NSSAI 1 receives a predetermined trigger event, the electronic apparatus 100 on the NSACF 1 or the control unit 101 or the NSACF 1 performs admission control of the network slice S-NSSAI 1 based on the blockchain. In the following description of a processing procedure, the electronic apparatus 100 or the control unit 101 and the NSACF 1 are not particularly distinguished from each other.

For example, the control unit 101 may query admission control information of another NSACF (for example, NSACF 2 and NSACF 3) corresponding to the current network slice (for example, S-NSSAI 1) on the blockchain, and perform the admission control of the current network slice based on the admission control information of the first NSACF and the admission control information of the other NSACF.

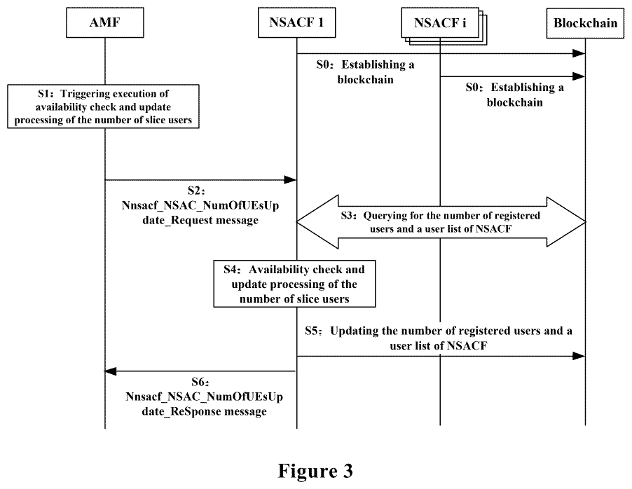

As an example, the admission control includes availability check and update processing of the number of slice users, that is, admission control of the number of slice users. A purpose of this control is, for example, to ensure that the number of registered users of all NSACFs in one network slice does not exceed a registered user number quota thereof. For ease of understanding, FIG. 3 shows an example of a relevant information flow of admission control of the number of slice users. It should be noted that this is exemplary rather than restrictive.

At S0, NSACFs of the network slices formed a blockchain, and admission control information of each NSACF is recorded on the blockchain. FIG. 3 shows only an example of the NSACF. It should be understood that the number of NSACFs is not limited to that shown in the figure, but may be any natural number.

At S1, occurrence of a predetermined trigger event causes AMF to perform availability check and update processing of the number of slice users. The predetermined trigger event may include one of the following: user registration, user de-registration, and configuration update of user equipment. The user registration means that new user equipment (UE) is to be registered to the current network slice, which may therefore cause an increase in the number of users. The user de-registration means that existing UE in the current network slice is to cancel registration, which may therefore cause a reduction in the number of users. The configuration update of user equipment may be caused, for example, due to Network Slice-specific Authentication and Authorization (NSSAA) or subscription slice change. The AMF performs availability check and update processing of the number of slice users for only a network slice that requires NSAC, and the AMF can configure which network slice requires NSAC.

Next, at S2, the AMF selects NSACF 1, for example, based on an area where the relevant UE is located, and sends, to NSACF 1, a request message for updating the number of users, such as a message Nnsacf_NSAC_NumOfUEsUpdate_Request; and NSACF 1 performs availability check and update processing of the number of slice users in response to the message. The message may include one or more of the following: user equipment identification (UE ID), access type, current network slice number (S-NSSAI), network function identification (NF ID), and update flag. Specifically, the access type may indicate a 3GPP access or a non-3GPP access. The current network slice number indicates which network slice is a current network slice, and the number may be the S-NSSAI (single network slice selection auxiliary information) of a network slice. Referring to the example in FIG. 2, the current network slice number is S-NSSAI 1. The NF ID indicates a network function that initiated the message, here referring to the AMF. The update flag varies depending on the trigger event. For example, the update flag indicates an increase of the number of registered users in a case of user registration, and a decrease of the number of registered users in a case of user de-registration. In addition, the update flag may indicate not to update a UE status in the current network slice.

Alternatively, NSACF 1 may determine whether to perform the admission control of the current network slice, for example, based on the access type or based on the access type and configuration information thereof. In a case of determining to perform the admission control of the current network slice, the admission control information of the first NSACF and/or the other NSACF is updated based on the update flag.

For example, at S3, NSACF 1 queries the blockchain for relevant admission control information of the NSACF (such as NSACF 2 and NSACF 3) corresponding to S-NSSAI 1. In S4, availability check and update processing of the number of slice users is performed based on the relevant admission control information of NSACF 1 to NSACF 3. In this example, the relevant admission control information of the NSACF may include one or more of the following: the number of registered users of the NSACF, and a user list of the NSACF.

Processing in S4 is described in detail below. In a case that the update flag indicates an increase, it means that user equipment corresponding to the user equipment identification requests registration. NSACF 1 checks whether the user equipment identification is in the user list of the NSACF 1 or the other NSACF. In a case that the user equipment identification is in the user list of the NSACF 1 or the other NSACF, a new entry for registration of the user equipment is created, without changing the number of registered users of the current network slice, that is, without changing the number of registered users of NSACF 1. The new entry may include the network function identification. In this way, multiple entries for the same user equipment identification can be distinguished based on the NF ID that initiated the request. On the other hand, in a case that the user equipment identification is not in the user list of NSACF 1 or the other NSACF, NSACF 1 may calculate the total number of registered users recorded by all NSACFs (such as NSACF 1 to NSACF 3) of the current network slice. In a case that the total number of users does not reach the registered user number quota of the current network slice, NSACF 1 add the user equipment identification to the user list of NSACF 1, and the number of registered users of NSACF 1 is increased by 1 correspondingly. In a case that the total number of users has reached the registered user number quota of the current network slice, meaning that the current network slice cannot receive any new user, the NSACF 1 returns information indicating that the current network slice has reached the registered user number quota as a response message to updating of the number of users, such as Nnsacf_NSAC_NumOfUEsUpdate_Response shown in S6 of FIG. 3.

In a case that the update flag indicates a decrease, it means that user equipment corresponding to the user equipment identification requests de-registration. In a case that there is only one entry associated with the user equipment identification in NSACF 1 and the other NSACF, the entry is deleted and the number of registered users of the corresponding NSACF is reduced. In a case that there are multiple entries associated with the user equipment identification in NSACF 1 and the other NSACF, only the entry associated with the NF ID (i.e., AMF) is deleted and the user equipment identification is still remained in the user list.

Next, in S5, NSACF 1 updates the relevant admission control information of NSACF 1 and/or the other NSACF on the blockchain, that is, the number of registered users and the user list of the corresponding NSACF. For example, Proof of stake (PoS) or Delegated Proof of Stake (DPoS) may be utilized to achieve consensus of blockchain nodes and thereby improve processing efficiency, which is yet not restrictive. By updating the admission control information on the blockchain, all NSACFs can be enabled to obtain consistent admission control information for the same network slice. Thereby, coordinated operations and sharing of slice admission quota for the network slice is realized.

In S6, NSACF 1 sends, to the AMF, a response to updating of the number of users, such as Nnsacf_NSAC_NumOfUEsUpdate_Response, to indicate whether the registered user number quota of the current network slice has been reached.

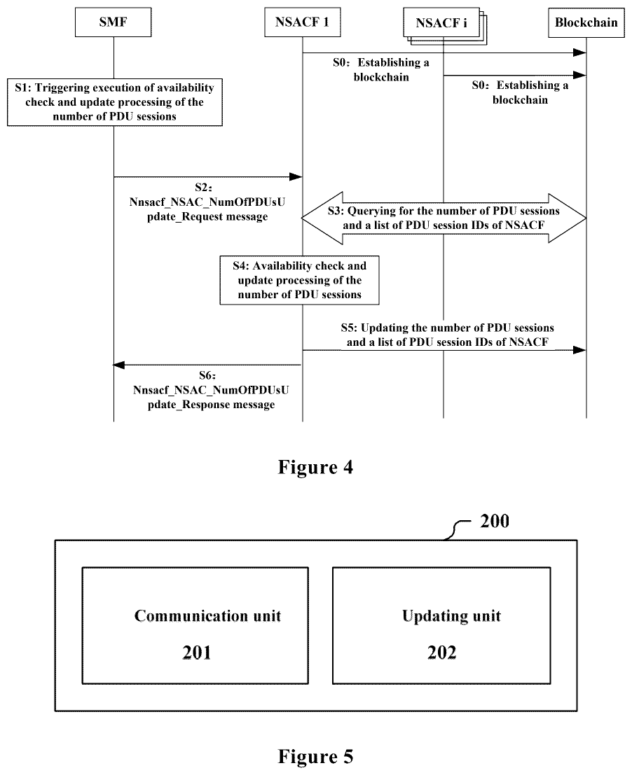

As another example, the admission control includes availability check and update processing of the number of PDU sessions. A purpose of this control is, for example, to ensure that the number of PDU sessions in one network slice does not exceed a PDU session number quota thereof. For ease of understanding, FIG. 4 shows an example of a relevant information flow of admission control of the number of PDU sessions. It should be noted that this is exemplary rather than restrictive.

Same as S0 in FIG. 3, NSACFs of the network slices form a blockchain at S0, and admission control information of each NSACF is recorded on the blockchain. It can be understood that the blockchain here may be the same blockchain as the blockchain described with reference to FIG. 3, which records the admission control information under both the two examples together. When used, NSACF queries for corresponding admission control information as needed.

At S1, occurrence of a predetermined trigger event causes SMF to perform availability check and update processing of the number of PDU sessions. The predetermined trigger event may include, for example, one of the following: start of new PDU session establishment, completion of PDU session release, failure of PDU session establishment, and inter access type mobility. The start of new PDU session establishment indicates an increase of the number of PDU sessions of the network slice. The completion of PDU session release and the failure of PDU session establishment indicate a decrease of the number of PDU sessions of the network slice. The inter access type mobility indicates that an access type of an existing PDU session is changed to a new access type.

Next, at S2, the SMF selects NSACF 1, for example, based on an area where relevant UE is located, and sends, to NSACF 1, a request message for updating the number of sessions, such as a Nnsacf_NSAC_NumOfPDUsUpdate_Request message; and NSACF 1 performs availability check and update processing of the number of slice PDU sessions in response to the message. The message may include one or more of the following: user equipment identification, access type, current network slice number, PDU session identification, and an update flag. Specifically, the access type may indicate a 3GPP access or a non-3GPP access. The current network slice number indicates which network slice is a current network slice, and the number may be the S-NSSAI of a network slice, such as S-NSSAI 1 in FIG. 2. The update flag varies depending on the trigger event. For example, the update flag indicates an increase of the number of PDU sessions in a case of the start of new PDU session establishment, and a decrease of the number of PDU sessions in a case of the completion of PDU session release or the failure of PDU session establishment. In a case of the inter access type mobility, the update flag indicates a change in an access type of an existing PDU session.

At S3, NSACF 1 queries the blockchain for relevant admission control information of the NSACF (such as NSACF 2 and NSACF 3) corresponding to S-NSSAI 1. In S4, availability check and update processing of the number of PDU sessions is performed based on the relevant admission control information of NSACF 1 to NSACF 3. In this example, the relevant admission control information of the NSACF may include one or more of the following: the number of PDU sessions of the NSACF, and a list of PDU session identifications (IDs) of the NSACF.

In S4, NSACF 1 may update the admission control information of NSACF 1 and/or the other NSACF based on the update flag. Processing in S4 is described in detail below.

In a case that the update flag indicates an increase, the predetermined trigger event is, for example, the start of new PDU session establishment. NSACF 1 calculates the total number of PDU sessions recorded by all NSACFs (such as NSACF 1 to NSACF 3) of the current network slice. In a case that the total number of sessions has reached a PDU session number quota of the current network slice, NSACF 1 returns information indicating that the current network slice has reached the PDU session number quota. In a case that the total number of sessions has not reached the PDU session number quota of the current network slice, NSACF 1 increases the number of PDU sessions of NSACF 1. Additionally, NSACF 1 stores the PDU session identification and the access type in a case that the user equipment identification exists in the list of PDU session IDs of the first NSACF or the other NSACF; and NSACF 1 creates a new entry to record the user equipment identification, the PDU session identification and the access type in an associated manner in a case that the user equipment identification does not exist in the list of PDU session IDs of the first NSACF or the other NSACF.

In a case that the update flag indicates a decrease, the predetermined trigger event is the completion of PDU session release or the failure of PDU session establishment, NSACF 1 reduces the number of PDU sessions, and deletes the PDU session identification. In addition, NSACF 1 further searches whether there is a PDU session associated with the user equipment identification in the other NSACF, and deletes the entry for the user equipment identification in a case that there is no PDU session associated with the user equipment identification.

In a case that the update flag indicates an update, NSACF 1 updates an access type in a record associated with the PDU session identification. In this case, the same user equipment identification may be associated with entries with different access types, and the NSACF can save a record for each of the access types and return a corresponding indication respectively.

Next, in S5, NSACF 1 updates the relevant admission control information of NSACF 1 and/or the other NSACF on the blockchain, that is, the number of PDU sessions and the list of PDU session identifications of the corresponding NSACF. For example, PoS or DPoS may be utilized to achieve consensus of blockchain nodes to improve processing efficiency, which is yet not restrictive.

In S6, NSACF 1 sends, to the SMF, a response to updating of the number of PDU sessions, such as Nnsacf_NSAC_NumOfPDUsUpdate_Response, to indicate an updating result. For example, in a case that a response is returned indicating that the current network slice has reached the PDU session number quota, the SMF rejects the request for new PDU session establishment.

In addition, even if the SMF agrees to the request for new PDU session establishment based on the response to updating of the number of PDU sessions such as Nnsacf_NSAC_NumOfPDUsUpdate_Response, there may be a situation that the PDU session establishment fails. In this case, the SMF would trigger new availability check and update processing of the number of slice PDU sessions, in which the update flag indicates a decrease of the number of PDU sessions. Thereby, the increased number of PDU sessions of the NSACF is reduced.

In summary, with the electronic apparatus 100 according to the embodiment of the present disclosure, NSACFs formed the blockchain, and the blockchain technology can be utilized to realize coordination of admission control among different NSACFs of the same network slice, and the quota of the network slice is shared.

Further, the control circuit 101 may be further configured to dynamically update a slice admission quota of each network slice on the blockchain. In other words, the slice admission quota for each network slices may also be stored on the blockchain to be updated dynamically.

For example, the slice admission quota may include a registered user number quota and/or a PDU session number quota. For example, the control circuit 101 may perform dynamic updating based on an instruction or spectrum sensing information provided by a radio access network (RAN). A detailed description of the spectrum sensing information will be given in the second embodiment.

The electronic apparatus 100 with such configuration can dynamically update the slice admission quota of each network slice based on the actual situation, so that a spectrum usage efficiency of the radio network is effectively optimized.

### Second Embodiment

FIG. 5 shows a block diagram of functional modules of an electronic apparatus 200 according to another embodiment of the present disclosure. As shown in FIG. 5, the electronic apparatus 200 includes: a communication unit 201 configured to acquire spectrum sensing information from an RAN side; and an updating unit 202 configured to dynamically update a slice admission quota of each network slice in a mobile network based on the spectrum sensing information.

The communication unit 201 and the updating unit 202 may be implemented by one or more processing circuits. The processing circuitry may be implemented as a chip or a processor, for example. It should be understood that various functional units in the electronic apparatus shown in FIG. 5 are only logical modules determined based on specific functions thereof, and are not for limiting a specific implementation.

For example, the electronic apparatus 200 may be provided on a core network side of a mobile network, specifically on a server on the core network side. Examples of the mobile network include, for example, a PLMN.

Here, it should be noted that the electronic apparatus 200 may be implemented at a chip level or at a device level. For example, the electronic apparatus 200 may operate as the server itself and may further include a memory, a transceiver (not shown), and other external devices. The memory may store related data information and programs that the electronic apparatus needs to execute to achieve various functions. The transceiver may include one or more communication interfaces to support communications with different devices (such as another server, a base station, and the like). An implementation of the transceiver is not specifically limited here.

Reference is made back to FIG. 2. The present disclosure proposes to add a sensing plane function (SPF) to the core network. The SPF may be used to process and report sensing information, provide sensing capabilities and information to a third-party entity (such as a spectrum management device), and perform transaction of a slice spectrum resource and update of a slice admission quota, or the like, in conjunction with a Network Data Analytics Function (NWDAF). The electronic apparatus 200 of the embodiment may be implemented on the SPF or serve as a part of the SPF. In the following description of a processing procedure, the electronic apparatus 200 or functional units thereof and the SPF are not particularly distinguished from each other.

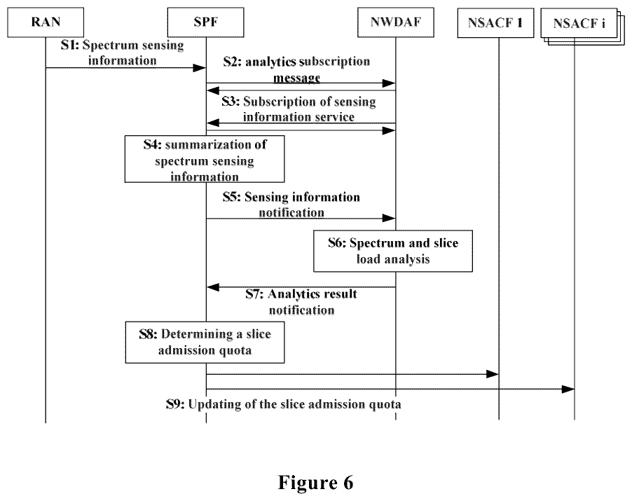

For ease of understanding, FIG. 6 shows an example of an information flow of updating a slice admission quota. It should be noted that this information flow is exemplary rather than restrictive.

First, in S1, RAN sends spectrum sensing information to SPF. For example, the RAN may perform the transmission periodically or in response to a specific trigger event. The spectrum sensing information includes one or more of the following: radio measurement information, non-3GPP type information, spectrum transaction information, and the like. The radio measurement information includes, for example, a used frequency band, bandwidth, power, a channel status, and the like. The Non-3GPP type information includes, for example, location information.

In S2, the SPF may send an analytics subscription message (such as Nnwdaf_AnalyticsSuscription_Subscribe message) to NWDAF. The analytics subscription message may include an analytics identification and/or an analytics filter. Various analytics functions may be performed in the NWDAF, such as slice load statistics and/or prediction, spectrum transaction analytics, spectrum and load level analytics, and the like. The analytics identification may be used to indicate which analytics is to be subscribed (or which analytics function of the NWDAF is to be invoked). The analytics filter is for determining an object to which the analytics function is to be applied. The analytics filter includes, for example, one or more of the following: S-NSSAI, network slice instance identification (NSI ID), and a region of interest. Therefore, the SPF can invoke a corresponding analytics function of the NWDAF by sending an analytics subscription message to the NWDAF, so as to analyze desired object data.

In S3, the NWDAF subscribes to the SPF for a sensing information service, for example, by sending a Nspf_EventExposure_Subscribe message, to obtain spectrum sensing information.

In S4, the SPF summarizes the received spectrum sensing information into a predetermined format and packages in a predetermined period. For example, the SPF may summarize the spectrum sensing information into a unified format based on slices, base stations, spectrums, or the like.

In S5, the SPF periodically provides the packaged spectrum sensing information to the NWDAF in response to the subscription of the sensing information service in S3, for example, via a Nspf_EventExposure_Notify message.

In S6, the NWDAF analyzes the spectrum sensing information, for example, by performing spectrum and slice load analytics. In S7, the NWDAF provides an analytics result to the SPF in response to the analytics subscription message in S2, for example, via a Nnwdaf_AnalyticsSuscription_Notify message. For example, the analytics result may include one or more of the following: load statistics of each network slice, future load prediction of each network slice, load statistics of a service area of a network slice, future load prediction of a service area of a network slice, and the number of registered users and/or PDU sessions that each network slice is able to carry. Specific content of the analytics result depends, for example, at least in part on the analytics subscription messages in S2.

In S8, the SPF determines a slice admission quota for each network slice based on the received analytics result. As mentioned above, the slice admission quota may include a registered user number quota and/or a PDU session number quota.

In S9, the SPF sends a slice admission quota update indication (for example, a NS Quota Update message) to each NSACF. It is to be noted that in a case that the slice admission quota of a certain network slice is not updated in a certain processing period, the SPF may not send the slice admission quota update indication to the NSACF. FIG. 6 shows only an example of the NSACF. It should be understood that the number of NSACFs is not limited to that shown in the figure, but may be any natural number.

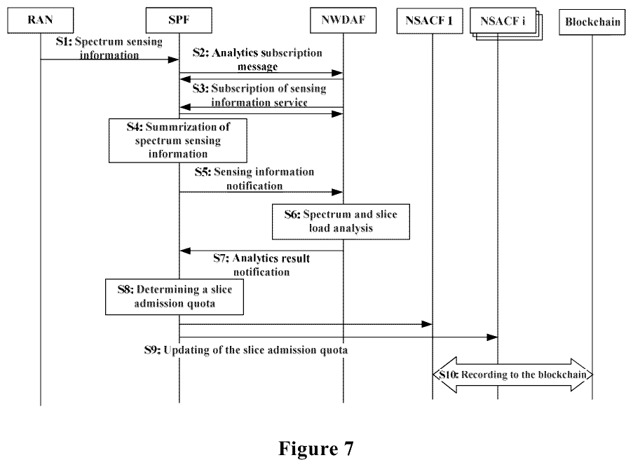

FIG. 7 shows another example of an information flow of updating a slice admission quota. Step S1 to step S9 in FIG. 7 are the same as S1 to S9 in FIG. 6 and are not repeated here. In S10 of the figure, the slice admission quota of each network slice is dynamically updated on the blockchain, where NSACFs of network slices form the blockchain.

In summary, with the electronic apparatus 200 according to the embodiment of the present disclosure, the slice admission quota of each network slice is dynamically updated based on the spectrum sensing information, so that a spectrum usage efficiency of the radio network can be effectively optimized.

### Third Embodiment

In the description of the electronic apparatuses for network management in the above embodiments, some processes or methods are further disclosed. Hereinafter, an overview of the methods is given without repeating some of details discussed above. It should be noted that although disclosed in the description of the electronic apparatuses for network management, the methods do not necessarily adopt the components as described or be performed by those components. For example, an embodiment of the electronic apparatus for network management may be implemented partially or entirely using hardware and/or firmware, while a method for network management discussed below may be implemented entirely by a computer-executable program, although the method may employ the hardware and/or firmware for the electronic apparatus for network management.

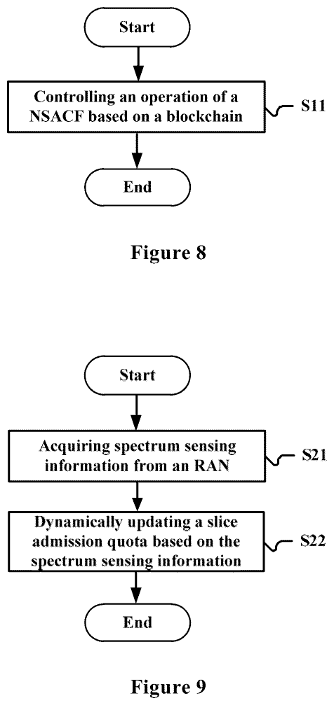

FIG. 8 shows a flow chart of a method for network management according to an embodiment of the present disclosure. The method includes: controlling, based on a blockchain, an operation of a Network Slice Admission Control Function (NSACF) of a network slice in a mobile network, where the NSACF has a blockchain function (S11). The method may be performed on a core network side, for example.

For example, one network slice corresponds to one or more NSACFs. The blockchain records admission control information of each NSACF of each network slice.

As an example, in step S11, in response to a predetermined trigger event with respect to a first NSACF, admission control of a current network slice corresponding to the first NSACF is performed based on the blockchain.

For example, admission control information of another NSACF corresponding to the current network slice may be queried on the blockchain, and the admission control of the current network slice may be performed based on the admission control information of the first NSACF and the admission control information of the other NSACF.

The admission control includes, for example, availability check and update processing of the number of slice users, and the predetermined trigger event includes one of the following: user registration, user de-registration, and configuration update of user equipment. The admission control information of the NSACF may include one or more of the following: the number of registered users of the NSACF, and a user list of the NSACF.

Step S11 includes: receiving, from the AMF, a request message for updating the number of users with respect to the first NSACF, such as a message Nnsacf_NSAC_NumOfUEsUpdate_Request, and performing availability check and update processing of the number of slice users in response to the message. The message may include one or more of the following: user equipment identification, access type, current network slice number, network function identification, and update flag.

Step S11 may further include: determining, based on the access type, whether to perform the admission control of the current network slice; and in a case of determining to perform the admission control of the current network slice, updating the admission control information of the first NSACF and/or the other NSACF based on the update flag.

For example, in a case that the update flag indicates an increase, the user equipment corresponding to the user equipment identification requests registration. It is checked whether the user equipment identification is in the user list of the first NSACF or the other NSACF. In a case that the user equipment identification is in the user list of the first NSACF or the other NSACF, a new entry is created for the registration of the user equipment, without changing the number of registered users of the current network slice. The new entry includes the network function identification. In a case that the user equipment identification is not in the user list of the first NSACF or the other NSACF, and the total number of users recorded by the first NSACF and the other NSACFs does not reach a registered user number quota of the current network slice, the user equipment identification is added to the user list of the first NSACF. In a case that the user equipment identification is not in the user list of the first NSACF or the other NSACF, and the total number of users recorded by the first NSACF and the other NSACF has reached the registered user number quota of the current network slice, information indicating that the current network slice has reached the registered user number quota is returned.

The following is for a case that the update flag indicates a decrease. In a case that there is only one entry associated with the user equipment identification in the first NSACF and the other NSACF, the entry is deleted and the number of registered users of the corresponding NSACF is reduced. In a case that there are multiple entries associated with the user equipment identification in the first NSACF and the other NSACF, only the entry associated with the network function identification is deleted and the user equipment identification is remained in the user list.

On the other hand, the admission control includes, for example, availability check and update processing of the number of PDU sessions, and the predetermined trigger event includes one of the following: start of new PDU session establishment, completion of PDU session release, failure of PDU session establishment, and inter access type mobility. The admission control information of the NSACF includes, for example, one or more of the following: the number of PDU sessions of the NSACF, and a list of PDU session identifications of the NSACF.

Step S11 includes: receiving, from the SMF, a request message for updating the PDU sessions with respect to the first NSACF, such as a message Nnsacf_NSAC_NumOfPDUsUpdate_Request, and performing availability check and update processing of the number of slice PDU sessions in response to the message. The message includes one or more of the following: user equipment identification, an access type, a current network slice number, PDU session identification, and an update flag.

Step S11 further includes updating the admission control information of the first NSACF and/or the other NSACF based on the update flag.

For example, in a case that the update flag indicates an increase, the predetermined trigger event is the start of new PDU session establishment. In a case that the total number of PDU sessions recorded by the first NSACF and the other NSACF reaches a PDU session number quota of the current network slice, information indicating that the current network slice has reached the PDU session number quota is returned. In a case that the total number of sessions recorded by the first NSACF and the other NSACF does not reach the PDU session number quota of the current network slice, the number of PDU sessions of the first NSACF is increased, and the PDU session identification and the access type are stored in a case that the user equipment identification exists in the list of PDU session IDs of the first NSACF or the other NSACF, and a new entry is created to record the user equipment identification, the PDU session identification and the access type in an associated manner in a case that the user equipment identification does not exist in the list of PDU session IDs of the first NSACF or the other NSACF.

In a case that the update flag indicates a decrease, the predetermined trigger event is completion of PDU session release or failure of PDU session establishment. In this case, the number of PDU sessions of the first NSACF is reduced and the PDU session identification is deleted, and it is checked whether there is a PDU session associated with the user equipment identification in the other NSACF. The entry for the user equipment identification is deleted in a case that there is no PDU session associated with the user equipment identification.

In a case that the update flag indicates an update, an access type in a record associated with the PDU session identification is updated.

The method further includes updating, on the blockchain, the admission control information of the first NSACF and/or the other NSACF.

As another example, in S11, the slice admission quota of each network slice is dynamically updated on the blockchain. For example, the slice admission quota includes a registered user number quota and/or a PDU session number quota. The dynamic updating may be performed based on spectrum sensing information provided by the radio access network side.

The above method corresponds to the electronic apparatus 100 in the first embodiment. Reference can be made to the first embodiment for specific details of the method, which are not repeated here.

FIG. 9 shows a flow chart of a method for network management according to an embodiment of the present disclosure. The method includes: acquiring spectrum sensing information from a radio access network side (S21); and dynamically updating a slice admission quota of each network slice in a mobile network based on the spectrum sensing information (S22). The method may be performed on a core network side, for example.

For example, the slice admission quota includes a registered user number quota and/or a PDU session number quota. The spectrum sensing information includes one or more of the following: radio measurement information, non-3GPP type information, and spectrum transaction information.

In step S22, the spectrum sensing information may be summarized into a predetermined format, packaged according to a predetermined period to be provided to a network data analytics function NWDAF, an analytics result is obtained from the NWDAF, and the dynamic updating is performed based on the analytics result. The analytics result includes, for example, one or more of the following: load statistics of each network slice, future load prediction of each network slice, load statistics of a service area of a network slice, future load prediction of a service area of a network slice, and the number of registered users and/or PDU sessions that each network slice is able to carry.

Step S22 further includes: sending an analytics subscription message to the NWDAF, where the analytics subscription message includes analytics identification and/or an analytics filter.

The method may further include: performing dynamically updating on the blockchain, where NSACFs of network slices in the mobile network form the blockchain.

The above method corresponds to the electronic apparatus 200 in the second embodiment. Reference can be made to the second embodiment for specific details of the method, which are not repeated here.

It is to be noted that the above methods can be used in combination or alone.

The technology of the present disclosure can be applied to various products. For example, the electronic apparatus 100 or 200 may be implemented as any type of server, such as a tower server, a rack server, and a blade server. The electronic apparatus 100 or 200 may be a control module installed on a server (such as an integrated circuit module including a single wafer, and a card or blade inserted into a slot of a blade server).

### Application Examples Regarding a Server

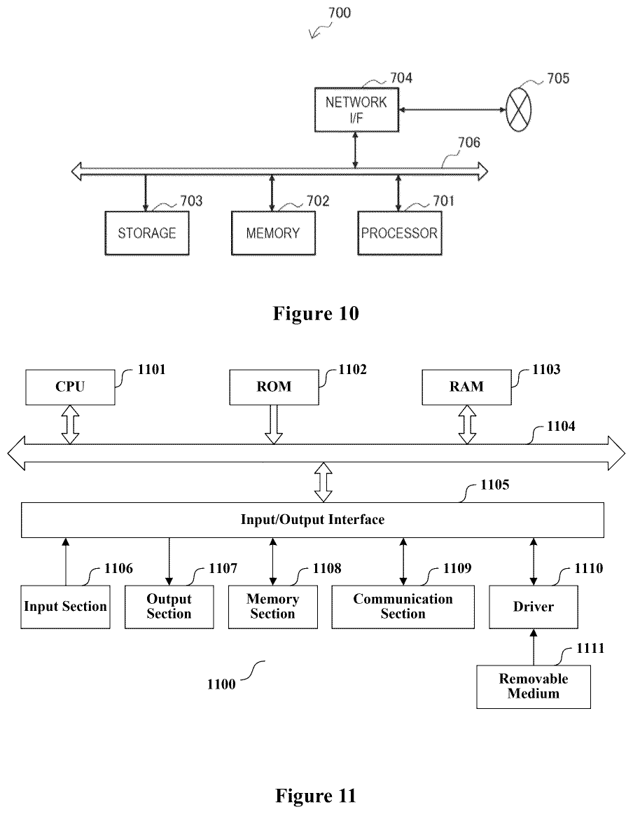

FIG. 10 is a block diagram showing an example of a schematic configuration of a server 700 to which the technology of the present disclosure may be applied. The server 700 includes a processor 701, a memory 702, a storage 703, a network interface (I/F) 704, and a bus 706.

The processor 701 may be, for example, a central processing unit (CPU) or a digital signal processor (DSP), and controls functions of the server 700. The memory 702 includes a random access memory (RAM) and a read-only memory (ROM), and stores data and a program executed by the processor 701. The storage 703 may include a storage medium, such as a semiconductor memory and a hard disk.

The network interface 704 is a wired communication interface for connecting the server 700 to a wired communication network 705. The wired communication network 705 may be a core network such as an Evolved Packet Core (EPC), or a packet data network (PDN) such as the Internet.

The bus 706 connects the processor 701, the memory 702, the storage 703, and the network interface 704 to each other. The bus 706 may include two or more buses having different speeds (such as a high-speed bus and a low-speed bus).

In the server 700 shown in FIG. 10, the control unit 101 described with reference to FIG. 1 and the communication unit 201 and the updating unit 202 described with reference to FIG. 5 may be implemented through the processor 701. For example, the processor 701 may implement the blockchain-based slice admission control by executing the functions of the control unit 101, and may implement the dynamic update of the slice admission quota based on the spectrum sensing information by executing the functions of the communication unit 201 and the updating unit 202.

The basic principle of the present disclosure has been described above in conjunction with particular embodiments. However, as can be appreciated by those ordinarily skilled in the art, all or any of the steps or components of the method and apparatus according to the disclosure can be implemented with hardware, firmware, software or a combination thereof in any computing device (including a processor, a storage medium, etc.) or a network of computing devices by those ordinarily skilled in the art in light of the disclosure of the disclosure and making use of their general circuit designing knowledge or general programming skills.

Moreover, the present disclosure further discloses a program product in which machine-readable instruction codes are stored. The aforementioned methods according to the embodiments can be implemented when the instruction codes are read and executed by a machine.

Accordingly, a memory medium for carrying the program product in which machine-readable instruction codes are stored is also covered in the present disclosure. The memory medium includes but is not limited to soft disc, optical disc, magnetic optical disc, memory card, memory stick and the like.

In the case where the present disclosure is realized with software or firmware, a program constituting the software is installed in a computer with a dedicated hardware structure (e.g. the general computer 1100 shown in FIG. 11) from a storage medium or network, wherein the computer is capable of implementing various functions when installed with various programs.

In FIG. 11, a central processing unit (CPU) 1101 executes various processing according to a program stored in a read-only memory (ROM) 1102 or a program loaded to a random access memory (RAM) 1103 from a memory section 1108. The data needed for the various processing of the CPU 1101 may be stored in the RAM 1103 as needed. The CPU 1101, the ROM 1102 and the RAM 1103 are linked with each other via a bus 1104. An input/output interface 1105 is also linked to the bus 1104.

The following components are linked to the input/output interface 1105: an input section 1106 (including keyboard, mouse and the like), an output section 1107 (including displays such as a cathode ray tube (CRT), a liquid crystal display (LCD), a loudspeaker and the like), a memory section 1108 (including hard disc and the like), and a communication section 1109 (including a network interface card such as a LAN card, modem and the like). The communication section 1109 performs communication processing via a network such as the Internet. A driver 1110 may also be linked to the input/output interface 1105, if needed. If needed, a removable medium 1111, for example, a magnetic disc, an optical disc, a magnetic optical disc, a semiconductor memory and the like, may be installed in the driver 1110, so that the computer program read therefrom is installed in the memory section 1108 as appropriate.

In the case where the foregoing series of processing is achieved through software, programs forming the software are installed from a network such as the Internet or a memory medium such as the removable medium 1111.

It should be appreciated by those skilled in the art that the memory medium is not limited to the removable medium 1111 shown in FIG. 11, which has program stored therein and is distributed separately from the apparatus so as to provide the programs to users. The removable medium 1111 may be, for example, a magnetic disc (including floppy disc (registered trademark)), a compact disc (including compact disc read-only memory (CD-ROM) and digital versatile disc (DVD), a magneto optical disc (including mini disc (MD) (registered trademark)), and a semiconductor memory. Alternatively, the memory medium may be the hard discs included in ROM 1102 and the memory section 1108 in which programs are stored, and can be distributed to users along with the device in which they are incorporated.

To be further noted, in the apparatus, method and system according to the present disclosure, the respective components or steps can be decomposed and/or recombined. These decompositions and/or re-combinations shall be regarded as equivalent solutions of the disclosure. Moreover, the above series of processing steps can naturally be performed temporally in the sequence as described above but will not be limited thereto, and some of the steps can be performed in parallel or independently from each other.

Finally, to be further noted, the term “include”, “comprise” or any variant thereof is intended to encompass nonexclusive inclusion so that a process, method, article or device including a series of elements includes not only those elements but also other elements which have been not listed definitely or an element(s) inherent to the process, method, article or device. Moreover, the expression “comprising a(n) . . . ” in which an element is defined will not preclude presence of an additional identical element(s) in a process, method, article or device comprising the defined element(s)” unless further defined.

Although the embodiments of the present disclosure have been described above in detail in connection with the drawings, it shall be appreciated that the embodiments as described above are merely illustrative rather than limitative of the present disclosure. Those skilled in the art can make various modifications and variations to the above embodiments without departing from the spirit and scope of the present disclosure. Therefore, the scope of the present disclosure is defined merely by the appended claims and their equivalents.

1. An electronic apparatus for network management, comprising:
at least one processor; and
at least one memory including computer program code, where the at least one memory and the computer program code are configured, with the at least one processor, to cause the electronic apparatus to:
control, based on a blockchain, an operation of a Network Slice Admission Control Function (NSACF) of a network slice in a mobile network,
wherein, the NSACF has a blockchain function.

2. The electronic apparatus according to claim 1, wherein, one network slice corresponds to one or more NSACFs, and
wherein, the blockchain records admission control information of each NSACF of each network slice.

3. (canceled)

4. The electronic apparatus according to claim 2, wherein the at least one memory and the computer program code are configured, with the at least one processor, to cause the electronic apparatus to perform, in response to a predetermined trigger event with respect to a first NSACF, admission control of a current network slice corresponding to the first NSACF based on the blockchain.

5. The electronic apparatus according to claim 4, wherein the at least one memory and the computer program code are configured, with the at least one processor, to cause the electronic apparatus to query admission control information of another NSACF corresponding to the current network slice on the blockchain, and perform the admission control of the current network slice based on the admission control information of the first NSACF and the admission control information of the other NSACF.

6. The electronic apparatus according to claim 4, wherein the admission control comprises availability check and update processing of the number of slice users, and the predetermined trigger event comprises one of the following: user registration, user de-registration, and configuration update of user equipment, and
wherein the admission control information of the NSACF comprises one or more of the following: the number of registered users of the NSACF, and a user list of the NSACF

7. (canceled)

8. The electronic apparatus according to claim 6, wherein
the at least one memory and the computer program code are configured, with the at least one processor, to cause the electronic apparatus to receive a request message for updating the number of users with respect to the first NSACF from an access and mobility function AMF, and perform the availability check and update processing of the number of slice users in response to the request message for updating the number of users; and
the request message for updating the number of users comprises one or more of the following: user equipment identification, an access type, a current network slice number, network function identification, and an update flag.

9. The electronic apparatus according to claim 8, wherein the at least one memory and the computer program code are further configured, with the at least one processor, to cause the electronic apparatus to:
determine, based on the access type, whether to perform the admission control of the current network slice; and
in a case of determining to perform the admission control of the current network slice, update the admission control information of the first NSACF and/or the other NSACF based on the update flag.

10. The electronic apparatus according to claim 9, wherein in a case that the update flag indicates an increase, user equipment corresponding to the user equipment identification requests registration, and the at least one memory and the computer program code are configured, with the at least one processor, to cause the electronic apparatus to:
check whether the user equipment identification is in the user list of the first NSACF or the other NSACF;
create a new entry for registration of the user equipment, without changing the number of registered users of the current network slice, in a case that the user equipment identification is in the user list of the first NSACF or the other NSACF, wherein the new entry comprises the network function identification;
add the user equipment identification to the user list of the first NSACF, in a case that the user equipment identification is not in the user list of the first NSACF or the other NSACF, and the total number of users recorded by the first NSACF and the other NSACF does not reach the registered user number quota of the current network slice; and
return information indicating that the current network slice has reached the registered user number quota, in a case that the user equipment identification is not in the user list of the first NSACF or the other NSACF, and the total number of users recorded by the first NSACF and the other NSACF has reached the registered user number quota of the current network slice, and/or
wherein in a case that the update flag indicates a decrease, the at least one memory and the computer program code are configured, with the at least one processor, to cause the electronic apparatus to:
in a case that there is only one entry associated with the user equipment identification in the first NSACF and the other NSACF, delete the entry and reduce the number of registered users of the corresponding NSACF; and
in a case that there is a plurality of entries associated with the user equipment identification in the first NSACF and the other NSACF, only delete an entry associated with the network function identification and retain the user equipment identification in the user list.

11. (canceled)

12. The electronic apparatus according to claim 4, wherein
the admission control comprises availability check and update processing of the number of slice protocol data unit (PDU) sessions,
the predetermined trigger event comprises one of the following: start of new PDU session establishment, completion of PDU session release, failure of PDU session establishment, and inter access type mobility, and
wherein the admission control information of the NSACF comprises one or more of the following: the number of PDU sessions of the NSACF, and a list of PDU session identifications of the NSACF.

13. (canceled)

14. The electronic apparatus according to claim 12, wherein
the at least one memory and the computer program code are configured, with the at least one processor, to cause the electronic apparatus to receive a request message for updating the number of PDU sessions with respect to the first NSACF from a session management function SMF, and perform the availability check and update processing of the number of slice PDU sessions in response to the message; and
the request message for updating the number of PDU sessions comprises one or more of the following: user equipment identification, an access type, a current network slice number, PDU session identification, and an update flag.

15. The electronic apparatus according to claim 14, wherein the at least one memory and the computer program code are configured, with the at least one processor, to cause the electronic apparatus to update the admission control information of the first NSACF and/or the other NSACF based on the update flag.

16. The electronic apparatus according to claim 15, wherein in a case that the update flag indicates an increase, the predetermined trigger event is start of new PDU session establishment, and the at least one memory and the computer program code are configured, with the at least one processor, to cause the electronic apparatus to:
return information indicating that the current network slice has reached the PDU session number quota, in a case that the total number of sessions recorded by the first NSACF and the other NSACF reaches the PDU session number quota of the current network slice; and
in a case that the total number of sessions recorded by the first NSACF and the other NSACF does not reach the PDU session number quota of the current network slice,
increase the number of PDU sessions of the first NSACF, and
store the PDU session identification and the access type in a case that the user equipment identification exists in the list of PDU session IDs of the first NSACF or the other NSACF, and
create a new entry to record the user equipment identification, the PDU session identification and the access type in an associated manner in a case that the user equipment identification does not exist in the list of PDU session IDs of the first NSACF or the other NSACF, and/or
wherein in a case that the update flag indicates a decrease, the predetermined trigger event is completion of PDU session release or failure of PDU session establishment, the at least one memory and the computer program code are configured, with the at least one processor, to cause the electronic apparatus to reduce the number of PDU sessions of the first NSACF and delete the PDU session identification, and
search whether there is a PDU session associated with the user equipment identification in the other NSACF, and delete the entry for the user equipment identification in a case that there is no PDU session associated with the user equipment identification, and/or
wherein in a case that the update flag indicates an update, the at least one memory and the computer program code are configured, with the at least one processor, to cause the electronic apparatus to update an access type in a record associated with the PDU session identification.

17-18. (canceled)

19. The electronic apparatus according to claim 5, wherein the at least one memory and the computer program code are configured, with the at least one processor, to cause the electronic apparatus to update the admission control information of the first NSACF and/or the other NSACF on the blockchain.

20. The electronic apparatus according to claim 1, wherein the at least one memory and the computer program code are further configured, with the at least one processor, to cause the electronic apparatus to dynamically update a slice admission quota of each network slice on the blockchain,
wherein the slice admission quota comprises a registered user number quota and/or a PDU session number quota, and
wherein the at least one memory and the computer program code are configured, with the at least one processor, to cause the electronic apparatus to perform the dynamic updating based on spectrum sensing information provided by the radio access network side.

21-22. (canceled)

23. An electronic apparatus for network management, comprising:
at least one processor; and
at least one memory including computer program code, where the at least one memory and the computer program code are configured, with the at least one processor, to cause the electronic apparatus to:
acquire spectrum sensing information from a radio access network side; and
dynamically update a slice admission quota of each network slice in a mobile network based on the spectrum sensing information.

24. (canceled)

25. The electronic apparatus according to claim 23, wherein the spectrum sensing information comprises one or more of the following: radio measurement information, non-3GPP type information, and spectrum transaction information.

26. The electronic apparatus according to claim 23, wherein the at least one memory and the computer program code are configured, with the at least one processor, to cause the electronic apparatus to summarize the spectrum sensing information into a predetermined format, package according to a predetermined period to provide to a network data analytics function NWDAF, obtain an analytics result from the NWDAF, and perform the dynamic updating based on the analytics result.

27. The electronic apparatus according to claim 26, wherein the at least one memory and the computer program code are further configured, with the at least one processor, to cause the electronic apparatus to send an analytics subscription message to the NWDAF, and the analytics subscription message comprises analytics identification and/or an analytics filter.

28. The electronic apparatus according to claim 26, wherein the analytics result comprises one or more of the following: load statistics of each network slice, future load prediction of each network slice, load statistics of a service area of a network slice, future load prediction of a service area of a network slice, and the number of registered users and/or PDU sessions that each network slice is able to carry.

29. (canceled)

30. A method for network management, comprising:
controlling, based on a blockchain, an operation of a Network Slice Admission Control Function (NSACF) of a network slice in a mobile network,
wherein, the NSACF has a blockchain function.

31-32. (canceled)
